(19) United States
(12) Patent Application Publication
(10) Pub. No.: US 2026/0203009 A1
(43) Pub. Date: Jul. 16, 2026

(54) AUDIO LINK ROUTING FOR DO NOT DISTURB STATUS

(71) Applicant: Motorola Mobility LLC, Chicago, IL (US)

(72) Inventors: Amit Kumar Agrawal, Bangalore (IN); Michael E. Russell, Lake Zurich, IL (US); Rohit Sisodia, Naperville, IL (US)

(73) Assignee: Motorola Mobility LLC, Chicago, IL (US)

(21) Appl. No.: 19/025,817

(22) Filed: Jan. 16, 2025

(51) Int. Cl. G06F 3/16

(52) U.S. Cl. CPC G06F 3/165

(57) ABSTRACT

Techniques for audio link routing for do not disturb status are described and are implementable to enable an active audio link to a wireless audio device to be managed for different devices. For instance, a first device and a second device may have wireless connectivity to a wireless audio device and the first device may have an active audio link to the wireless audio device. Further, the first device may be in a do not disturb mode. Accordingly, if an audio notification is received at the second device, implementations may prevent the active audio link to the first device from being interrupted to output the notification from the second device while the first device is in the do not disturb mode.

### BACKGROUND

The wide availability of wireless devices offers users a tremendous number of wireless connectivity options. For instance, wireless devices (e.g., mobile phones, laptops, wearable devices, etc.) can connect to wireless networks to perform different tasks. Further, wireless devices can directly interconnect such as to enable direct data intercommunication between wireless devices. In one particularly useful implementation, users can connect wireless audio devices (e.g., headphones, earbuds, etc.) to their wireless devices to enable audio to be streamed from the wireless devices to their wireless audio devices. In many scenarios, however, users have multiple different wireless devices and thus managing connectivity of a wireless audio device among multiple wireless connectivity sources can be challenging.

### BRIEF DESCRIPTION OF THE DRAWINGS

Aspects of audio link routing for do not disturb status are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of audio link routing for do not disturb status can be implemented.

FIG. 2 illustrates an example scenario for audio link routing for do not disturb status in accordance with one or more implementations.

FIG. 3 illustrates an example scenario for audio link routing for do not disturb status in accordance with one or more implementations.

FIG. 4 illustrates a flow chart depicting an example method for audio link routing for do not disturb status in accordance with one or more implementations.

FIG. 5 illustrates a flow chart depicting an example method for audio link routing for do not disturb status in accordance with one or more implementations.

FIG. 6 illustrates a flow chart depicting an example method for audio link routing for do not disturb status in accordance with one or more implementations.

FIG. 7 illustrates various components of an example device in which aspects of audio link routing for do not disturb status can be implemented.

### DETAILED DESCRIPTION

Techniques for audio link routing for do not disturb status are described and are implementable to enable connectivity of different devices (e.g., mobile devices, computing devices) to wireless audio devices (e.g., earbuds, headphones) to be managed based on do not disturb status of the different devices.

For example, consider a scenario in which a mobile phone and a laptop computer are both wirelessly connected to a set of wireless earbuds, e.g., via dual wireless connectivity. Further, the mobile phone has an active audio link to the wireless earbuds and a user is utilizing the mobile phone to perform a voice call via a communication application (e.g., a videoconference application) on the mobile phone. The wireless earbuds, for instance, can be used for voice output and voice input for the voice call. While the voice call is active and the mobile phone and laptop are both connected to the wireless earbuds, the laptop receives a notification that includes an audio notification. In some legacy scenarios, the laptop may interrupt the mobile phone's audio link to the wireless earbuds to output the audio notification, which may result in an unwanted interruption of the active voice call.

Accordingly, techniques described herein enable automated connectivity management and switching for wireless audio devices based on state information shared between different connected devices, including a do not disturb status of the connected devices. A connected device, for example, can activate a do not disturb mode where notifications and/or other messages are not to interrupt an audio link of the connected device.

For instance, in the scenario described above, a do not disturb mode may be active on the mobile phone, e.g., while the voice call is active. Accordingly, an arbitrator module on the mobile phone and/or the laptop can determine that, based on the active do not disturb mode on the mobile phone, the active audio link of the mobile phone to the wireless earbuds is not to be interrupted, e.g., disconnected. The arbitrator module can generate a routing rule that specifies that the active audio link of the mobile phone to the wireless earbuds is not to be interrupted, e.g., while the do not disturb mode is active on the mobile phone. The mobile phone and/or the laptop can implement the routing rule such that audio link of the mobile phone is not disconnected from the wireless earbuds and the laptop is not connected via an audio link the wireless earbuds to deliver the audio notification via the wireless earbuds.

In implementations, when the mobile phone deactivates the do not disturb mode, the active audio link to the wireless earbuds may be disconnected from the mobile phone and connected to the laptop to enable the audio notification to be output. Alternatively, or in addition, the laptop can transmit an indication of the received notification to the mobile phone, such as a summary of notifications received at the laptop while the mobile phone was in the do not disturb mode.

In implementations, routing rules can be generated that enable a do not disturb mode to be interrupted in different scenarios. For instance, in the scenario above where the mobile phone has an active audio link to the wireless earbuds and is in an active do not disturb mode, the laptop may receive a high priority notification. Different notifications can be flagged as high priority notifications, such as emergency notifications, notifications from specifically identified persons, etc. In such scenarios where a high priority notification is received, the active audio link of the mobile phone in the do not disturb mode can be disconnected and connected to the laptop to enable the high priority audio notification to be output via the wireless earbuds. In some examples, after output of the audio notification from the laptop, the active audio link can be automatically reconnected to the mobile phone. Other details and implementations of the described systems and techniques are described below and in the accompanying figures.

Accordingly, techniques for audio link routing for do not disturb status can be implemented to manage audio links between different devices and thus avoid scenarios where an active audio link of a device in a do not disturb mode may be interrupted.

While features and concepts of audio link routing for do not disturb status can be implemented in any number of environments and/or configurations, aspects of the described techniques are described in the context of the following example systems, devices, and methods. Further, the systems, devices, and methods described herein are interchangeable in various ways to provide for a wide variety of implementations and operational scenarios.

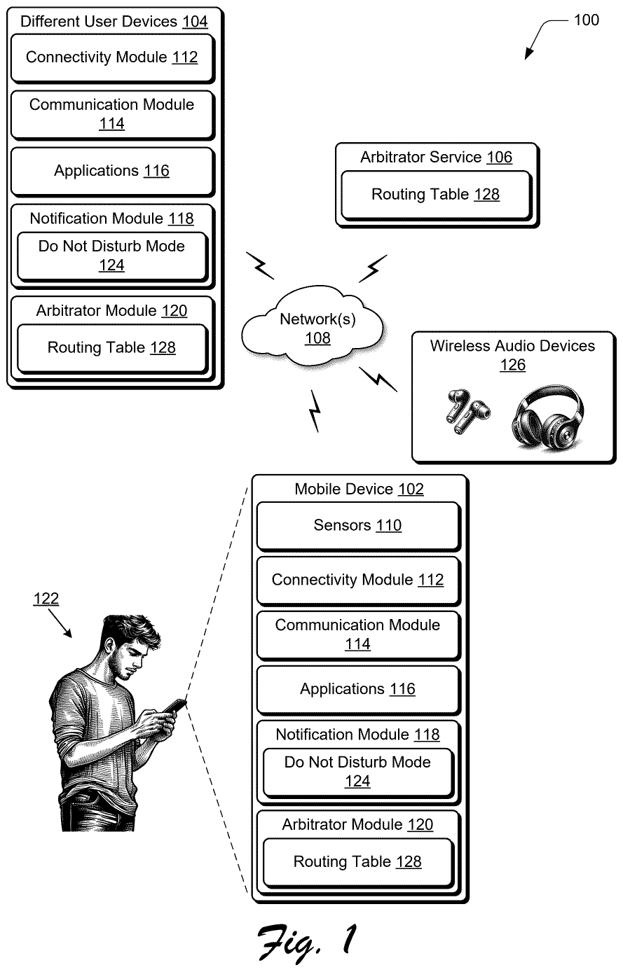

FIG. 1 illustrates an example environment 100 in which aspects of audio link routing for do not disturb status can be implemented. The environment 100 includes a mobile device 102, different user devices 104, an arbitrator service 106, and one or more network(s) 108. The mobile device 102 can be implemented in different ways, such as a mobile phone, a tablet device, a wearable device, an extended reality (e.g., virtual reality, mixed reality) device, etc. The different user devices 104 can also be implemented in different ways, such as a mobile device (examples of which are mentioned throughout this disclosure), a laptop computing device, a desktop computing device, a smart device system, etc. The arbitrator service 106 represents a network-based service that can communicate with the mobile device 102 and the different user devices 104 (e.g., via the network(s) 108) to perform and/or assist with various operations pertaining to audio link routing for do not disturb status described herein.

The network(s) 108 can represent instances and/or combinations of wireless and wired networks via which the mobile device 102, the different user devices 104, and the arbitrator service 106 can participate in various types of communication, such as wired and/or wireless data communication. The network(s) 108 can be implemented according to different architectures such as a wide area network (WAN), a wireless local area network (WLAN), peer-to-peer (P2P) networks, etc. For instance, (e.g., in P2P network scenarios), the mobile device 102 and the different user devices 104 can perform direct inter-device connectivity and data communication using any suitable connectivity protocol, such as Bluetooth, Bluetooth Low Energy (BLE) (e.g., via BLE advertisement), Generic Attribute Profile (GATT) communication, WiFi Direct, and/or any other suitable short-range wireless technology.

The mobile device 102 includes functionality that is operable in association with techniques for audio link routing for do not disturb status described herein including sensors 110, a connectivity module 112, a communication module 114, applications 116, a notification module 118, and an arbitrator module 120. The sensors 110 are representative of functionality to detect various physical and/or logical phenomena in relation to the mobile device 102, such as device location, position, motion, light, image detection and recognition, time and date, touch detection, sound (e.g., voice), temperature, and so forth. Examples of the sensors 110 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth. The sensors 110, however, can include a variety of other sensor types in accordance with the implementations discussed herein.

The connectivity module 112 represents functionality for enabling various types of wireless and wired connectivity and communication of the mobile device 102. The connectivity module 112, for instance, enables wireless connectivity and communication of the mobile device 102, such as connectivity and communication via the network(s) 108 and/or direct wireless connectivity between the mobile device 102 and the different user devices 104. The communication module 114 represents functionality for enabling various types of communication, such as voice communication, video communication, text communication, content communication, and combinations thereof. In at least some implementations the communication module 114 represents a multimedia communication application via which a user 122 of the mobile device 102 and/or the different user devices 104 can exchange different media types with other users, such as in real time.

The applications 116 represent functionality for performing different tasks via the mobile device 102, such as productivity applications, communication applications, entertainment applications, social media applications, etc. In at least one implementations, the communication module 114 represents an instance of the applications 116. The notification module 118 represents functionality for managing notifications received via the mobile device 102, such as voice calls, text messages, multimedia messages, application notifications associated with the applications 116, etc. The notification module 118 manages a do not disturb mode 124 for the mobile device 102. For instance, the user 122 can activate the do not disturb mode 124 for the mobile device 102, which can cause incoming notifications to be muted and/or delayed while the do not disturb mode 124 is active. For example, while the do not disturb mode 124 is active (e.g., activated), incoming notifications are not output by the mobile device 102. Further, while the do not disturb mode is inactive (e.g., deactivated), incoming notifications may be output by the mobile device 102.

The arbitrator module 120 represents functionality for performing various aspects of audio link routing for do not disturb status described herein. For instance, the arbitrator module 120 can manage connectivity and data routing for wireless audio devices 126. The wireless audio devices 126, for example, enable output of audio content (e.g., audio data streams) from the mobile device 102 and the different user devices 104. Examples of the wireless audio devices 126 include wireless earbuds, wireless headphones, wireless external speakers, and so forth. The user 122, for example, can utilize (e.g., wear) the wireless audio devices 126 to output audio content generated and/or obtained via the mobile device 102 and the different user devices 104.

The arbitrator module 120 includes and/or has access to a routing table 128 for managing audio connectivity and audio link routing to the wireless audio devices 126. The routing table 128, for instance, includes rules and parameters for determining which devices are to be connected to audio channels of the wireless audio devices 126. For example, the routing table 128 maps different devices and device states to priority values which can be used by the arbitrator module 120 to perform audio routing to the wireless audio devices 126. For instance, a device and/or device state with a higher priority value in the routing table 128 can be prioritized for audio routing to the wireless audio devices 126.

Further, the routing table 128 can specify that when the do not disturb mode 124 is active at the mobile device 102, an active audio link of the mobile device 102 to the wireless audio devices 126 is not to be disconnected, e.g., interrupted. For instance, the routing table 128 can specify that when the mobile device 102 has an audio link to a wireless audio device 126 and the do not disturb mode 124 is active at the mobile device 102, the audio link between the mobile device 102 and the wireless audio device 126 is not to be interrupted (e.g., disconnected), such as based on a notification received at a different user device 104. In at least one implementation, the routing table 128 can be implemented as a lookup table.

The arbitrator service 106 is representative of a network-based service that can assist in performing and/or assisting with various aspects of audio link routing for do not disturb status described herein. For instance, the arbitrator service 106 includes an instance of the routing table 128 that can be utilized to manage audio connectivity routing between the mobile device 102, the different user devices 104, and the wireless audio devices 126.

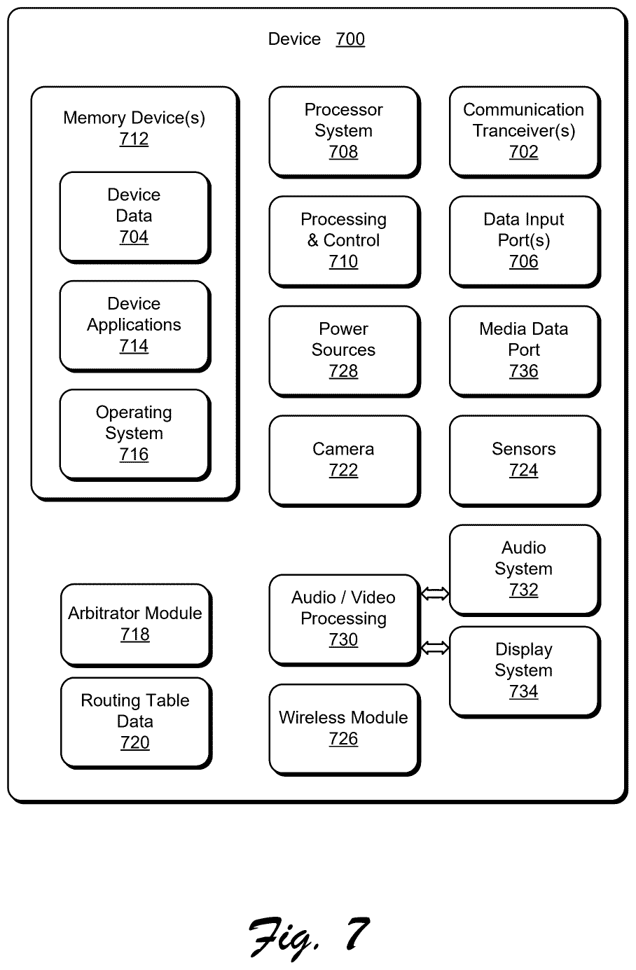

The different user devices 104 include instances of the connectivity module 112, the communication module 114, the applications 116, the notification module 118, and the arbitrator module 120, which are operable to perform various aspects of audio link routing for do not disturb status described herein, such as described with reference to the mobile device 102. The mobile device 102, the different user devices 104, and the arbitrator service 106 can be implemented in various ways and include various functionality, examples of which are discussed below with reference to the example device 700 of FIG. 7.

Having discussed an example environment in which the disclosed techniques can be performed, consider now some example scenarios and implementation details for implementing the disclosed techniques.

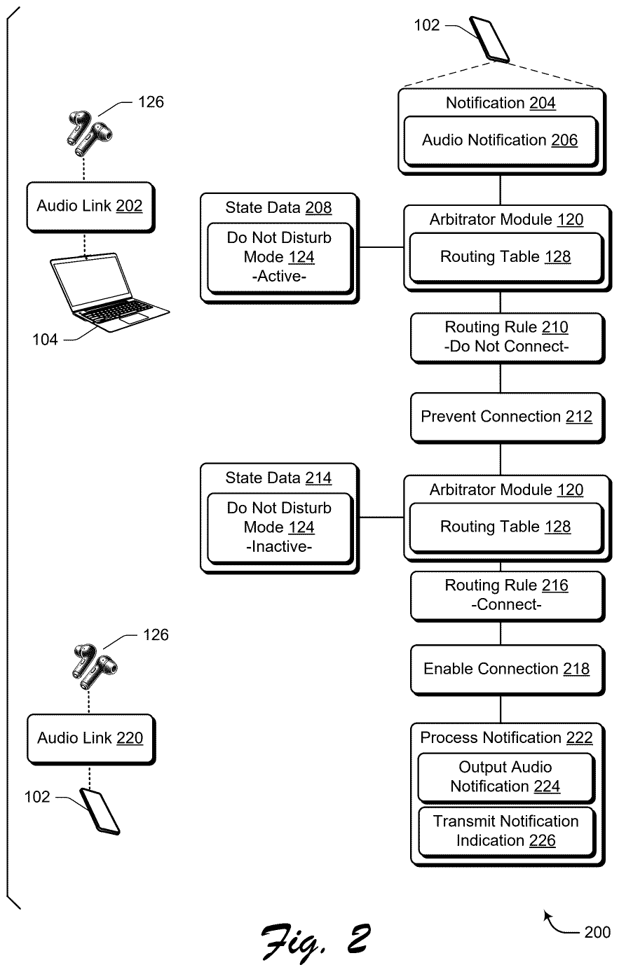

FIG. 2 illustrates an example scenario 200 for audio link routing for do not disturb status in accordance with one or more implementations. The scenario 200, for example, can be implemented in the context of the environment 100. In the scenario 200, the mobile device 102 determines that an audio link 202 to a wireless audio device 126 is available to both the mobile device 102 and a different user device 104, and that the audio link 202 to the wireless audio device 126 is connected to the different user device 104. While the audio link 202 is connected to the different user device 104, the mobile device 102 receives a notification 204 that includes an audio notification 206. Further, the arbitrator module 120 determines (e.g., receives) state data 208 that indicates that the do not disturb mode 124 is active on the different user device 104. According to implementations described herein, state data for different devices can be obtained in different ways, including via inter-device communication, via applications, via an application programming interface (API), etc.

Further to the scenario 200, the arbitrator module 120 compares the state data 208 to the routing table 128 to determine a routing rule 210 that indicates that the mobile device 102 is not to connect to the wireless audio device 126. The routing table 128, for example, indicates that when an audio link is connected to the different user device 104 and the do not disturb mode 124 is active on the different user device 104, the audio link 202 to the different user device 104 is not to be interrupted, e.g., disconnected.

Based at least in part on the routing rule 210, at 212 the mobile device 102 prevents connection of the mobile device 102 to the wireless audio device 126. The mobile device 102, for example, does not attempt to establish an audio link to the wireless audio device 126 to deliver the audio notification 206. In at least one implementation, the mobile device 102 stores the notification 204 in a notification queue, such as for subsequent output and/or delivery to the different user device 104.

Further to the scenario 200, the arbitrator module 120 determines (e.g., receives) state data 214 that indicates that the do not disturb mode 124 is inactive on the different user device 104, e.g., that the different user device 104 deactivates the do not disturb mode 124. Accordingly, the arbitrator module 120 compares the state data 214 to the routing table 128 to determine a routing rule 216 that indicates that the mobile device 102 is permitted to connect to the wireless audio device 126. In at least some implementations, at 218 the mobile device 102 connects to the wireless audio device 126 via an audio link 220. Further, at 222 the mobile device 102 processes the notification 204. For example, at 224 the mobile device 102 can cause the audio notification 206 to be output to the wireless audio device 126. Alternatively, or in addition, at 226 the mobile device 102 can transmit a notification indication of the notification 204 to the different user device 104. The notification indication, for example, can include the notification 204 and/or a summary of notifications that were received at the mobile device 102 while the do not disturb mode 124 was active on the different user device 104.

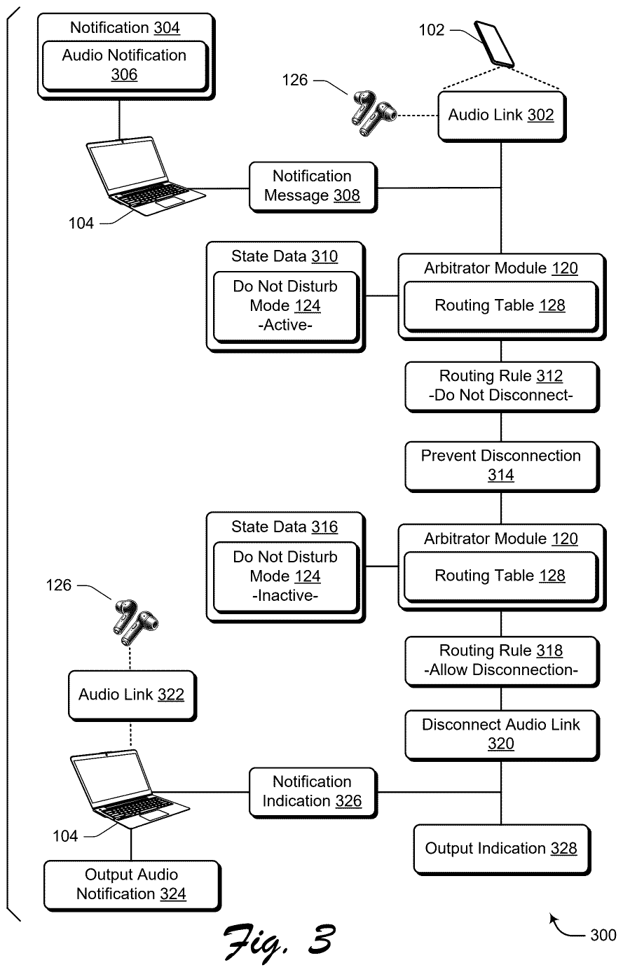

FIG. 3 illustrates an example scenario 300 for audio link routing for do not disturb status in accordance with one or more implementations. The scenario 300, for example, can be implemented in the context of the environment 100. In the scenario 300, the mobile device 102 determines that an audio link 302 to a wireless audio device 126 is available to both the mobile device 102 and a different user device 104, and that the audio link 302 to the wireless audio device 126 is connected to the mobile device 102. While the audio link 302 is connected to the mobile device 102, the different user device 104 receives a notification 304 that includes an audio notification 306. Further, the different user device 104 transmits a notification message 308 to the mobile device 102 indicating that the notification 304 is received at the different user device 104 and that the notification 304 includes the audio notification 306.

The arbitrator module 120 determines (e.g., receives) state data 310 that indicates that the do not disturb mode 124 is active on the mobile device 102, and compares the state data 310 to the routing table 128 to determine a routing rule 312. The routing rule 312, for instance, that indicates that the mobile device 102 is not to disconnect the audio link 302 to the wireless audio device 126. The routing table 128, for example, indicates that when an audio link is connected to the mobile device 102 and the do not disturb mode 124 is active on the mobile device 102, the audio link 302 to the mobile device 102 is not to be interrupted, e.g., disconnected.

Based at least in part on the routing rule 312, at 314 the mobile device 102 prevents connection of the mobile device 102 to the wireless audio device 126. The mobile device 102, for example, maintains the audio link 302. Further to the scenario 200, the arbitrator module 120 determines (e.g., receives) state data 316 that indicates that the do not disturb mode 124 is inactive on the mobile device 102, e.g., that the do not disturb mode 124 is deactivated on the mobile device 102. Accordingly, the arbitrator module 120 compares the state data 316 to the routing table 128 to determine a routing rule 318 that indicates that the mobile device 102 is permitted to allow disconnection of the audio link 302 to the wireless audio device 126.

In at least some implementations, at 320 the mobile device 102 disconnects the audio link 302 and the different user device 104 establishes an audio link 322 to the wireless audio device 126. At 324 the different user device 104 may output the audio notification 306 via the wireless audio device 126 and/or may transmit a notification indication 326 to the mobile device 102. The notification indication 326, for example, can include the notification 304 and/or a summary of notifications that were received at the different user device 104 while the do not disturb mode 124 was active on the mobile device 102. At 328 the mobile device 102 may output the notification indication, such as via audio and/or visual output.

While the scenarios 200, 300 are discussed with reference to operations of the mobile device 102, it is to be appreciated that similar and/or duplicate operations can be performed from the perspective and operations of a different user device 104 to control connectivity of an audio link to a wireless audio device 126. Further, the routing table 128 may indicate that exceptions for high priority notifications can be applied to enable an active audio link for a device in the do not disturb mode 124 to be interrupted to enable output of a high priority notification.

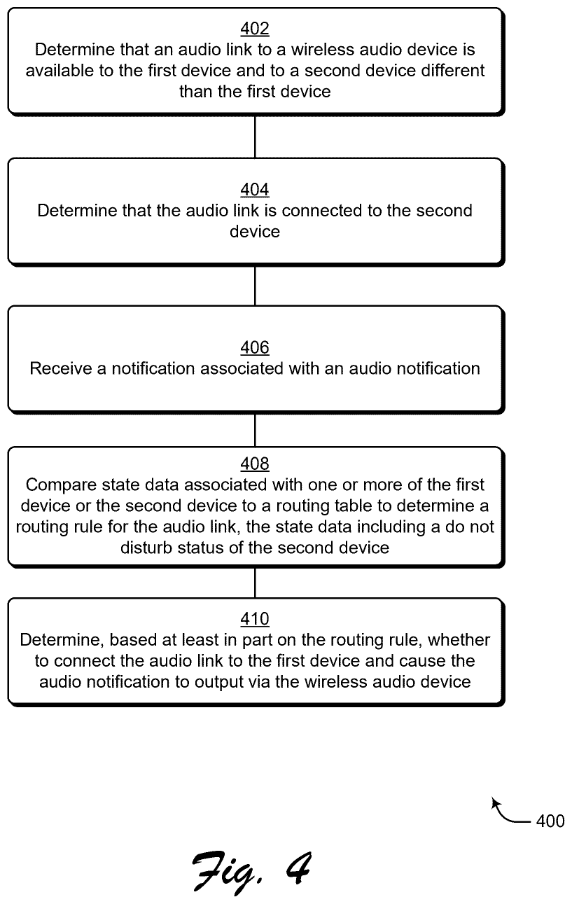

FIG. 4 illustrates a flow chart depicting an example method 400 for audio link routing for do not disturb status in accordance with one or more implementations. Operations of the method 400, for instance, may be performed in the context of the environment 100, such as by the mobile device 102, the different user devices 104, and/or the arbitrator service 106. For instance, the first device may represent the mobile device 102 and the second device may represent a different user device 104, or vice-versa.

At 402 it is determined that an audio link to a wireless audio device is available to the first device and to a second device different than the first device. The connectivity module 112, for example, determines that an audio link to a wireless audio device 126 is available to both the mobile device 102 and the different user device 104. At 404 it is determined that the audio link is connected to the second device. The connectivity module 112, for example, determines that an active audio link to the wireless audio device 126 is connected to the mobile device 102 or the different user device 104.

At 406 a notification associated with an audio notification is received. The notification module 118, for example, receives an indication of a notification. At 408 state data associated with one or more of the first device or the second device is compared to a routing table to determine a routing rule for the audio link, the state data including a do not disturb status of the second device. The arbitrator module 120, for example, compares state data for the mobile device 102 and/or the different user device 104 to determine whether the do not disturb mode 124 is active on either device. In implementations, if the do not disturb mode 124 is active on the second device, the routing rule may indicate that the first device is not to establish an audio link to the wireless audio device 126, e.g., to output the audio notification.

At 410 it is determined, based at least in part on the routing rule, whether to connect the audio link to the first device and cause the audio notification to output via the wireless audio device. For instance, where the routing rule indicates that the first device is not to establish an audio link to the wireless audio device 126, the first device may prevent an audio link between the first device and the wireless audio device 126 from being connected.

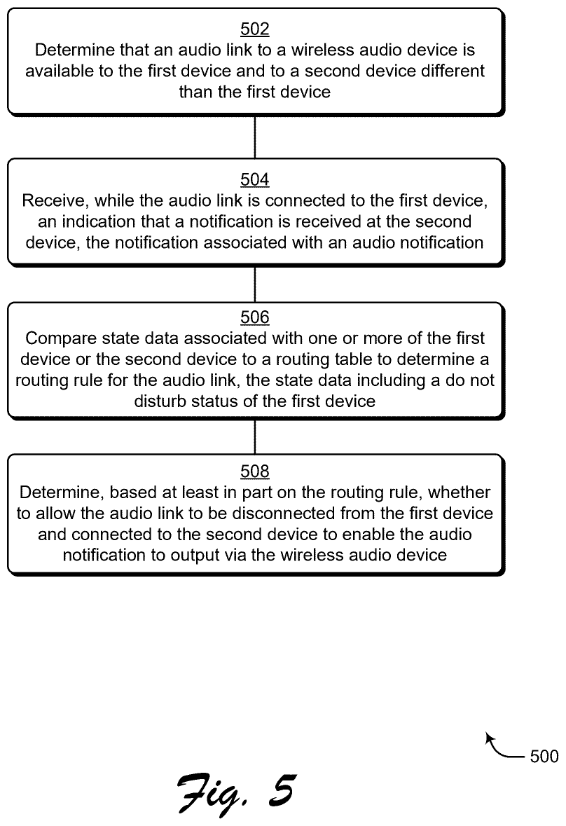

FIG. 5 illustrates a flow chart depicting an example method 500 for audio link routing for do not disturb status in accordance with one or more implementations. Operations of the method 500, for instance, may be performed in the context of the environment 100, such as by the mobile device 102, the different user devices 104, and/or the arbitrator service 106. For instance, the first device may represent the mobile device 102 and the second device may represent a different user device 104, or vice-versa.

At 502 it is determined that an audio link to a wireless audio device is available to the first device and to a second device different than the first device. The connectivity module 112, for example, determines that an audio link to a wireless audio device 126 is available to both the mobile device 102 and the different user device 104. At 504, while the audio link is connected to the first device, an indication is received that a notification is received at the second device, the notification associated with an audio notification. The second device, for example, transmits a notification message to the first device that a notification associated with an audio notification is received at the second device.

At 506 state data associated with one or more of the first device or the second device is compared to a routing table to determine a routing rule for the audio link, the state data including a do not disturb status of the first device. The arbitrator module 120, for example, compares state data for the mobile device 102 and/or the different user device 104 to determine whether the do not disturb mode 124 is active on either device. In implementations, if the do not disturb mode 124 is active on the first device, the routing rule may indicate that the first device is not to disconnect an active audio link to the wireless audio device 126, e.g., to enable the second device to establish an active audio link to the wireless audio device 126 to output the audio notification.

At 508 it is determined, based at least in part on the routing rule, whether to allow the audio link to be disconnected from the first device and connected to the second device to enable the audio notification to output via the wireless audio device. For instance, where the routing rule indicates that the first device is not to disconnect an audio link to the wireless audio device 126, the first device may prevent an audio link between the first device and the wireless audio device 126 from being disconnected, e.g., while the do not disturb mode 124 is active on the first device.

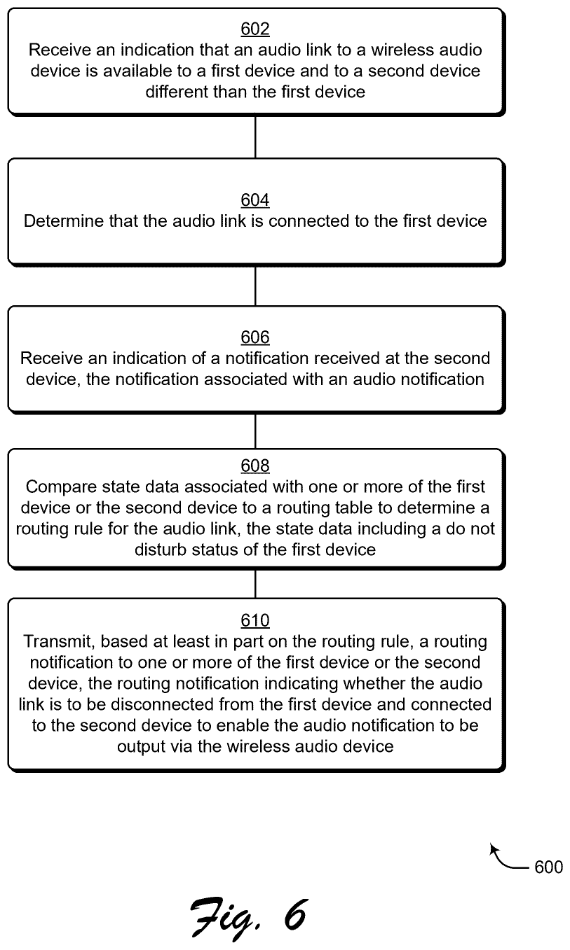

FIG. 6 illustrates a flow chart depicting an example method 600 for audio link routing for do not disturb status in accordance with one or more implementations. Operations of the method 600, for instance, may be performed in the context of the environment 100, such as by the mobile device 102, the different user devices 104, and/or the arbitrator service 106. For instance, the first device may represent the mobile device 102 and the second device may represent a different user device 104, or vice-versa.

At 602 an indication is received that an audio link to a wireless audio device is available to a first device and to a second device different than the first device. The arbitrator service 106, for example, receives communication from the first device and/or the second device that an audio link to a wireless audio device 126 is available to both the first device and the second device. At 604 it is determined that the audio link is connected to the first device. For instance, the arbitrator service 106 detects that the audio link to the wireless audio device 126 is connected to the first device.

At 606 an indication is received of a notification received at the second device, the notification associated with an audio notification. The arbitrator service 106, for example, receives an indication that a notification that includes an audio notification is received at the second device. At 608 state data associated with one or more of the first device or the second device is compared to a routing table to determine a routing rule for the audio link, the state data including a do not disturb status of the first device. The arbitrator service 106, for example, compares state data for the mobile device 102 and/or the different user device 104 to determine whether the do not disturb mode 124 is active on either device. In implementations, if the do not disturb mode 124 is active on the first device, the routing rule may indicate that the first device is not to disconnect an active audio link to the wireless audio device 126, e.g., to enable the second device to establish an active audio link to the wireless audio device 126 to output the audio notification.

At 610, based at least in part on the routing rule, a routing notification is transmitted to one or more of the first device or the second device, the routing notification indicating whether the audio link is to be disconnected from the first device and connected to the second device to enable the audio notification to be output via the wireless audio device. The arbitrator service 106, for example, transmits a routing notification to the first device and/or the second device indicating whether the audio link is to be disconnected from the first device and connected to the second device for output of the audio notification.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 7 illustrates various components of an example device 700 in which aspects of audio link routing for do not disturb status can be implemented. The example device 700 can be implemented as any of the devices described with reference to the previous FIGS. 1-6, such as any type of mobile device, mobile phone, mobile device, wearable device, tablet, computing, communication, entertainment, gaming, media playback, and/or other type of electronic device. For example, the mobile device 102, the different user devices 104, and/or the arbitrator service 106 as shown and described with reference to FIGS. 1-6 may be implemented as the example device 700.

The device 700 includes communication transceivers 702 that enable wired and/or wireless communication of device data 704 with other devices. The device data 704 can include one or more of device identifying data, device location data, wireless connectivity data, and wireless protocol data. Additionally, the device data 704 can include any type of audio, video, and/or image data. Example communication transceivers 702 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 700 may also include one or more data input ports 706 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 700 includes a processing system 708 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 710. The device 700 may further include any type of a system bus or other data and command transfer system that couples the various components within the device. A system bus can include any one or combination of different bus structures and architectures, as well as control and data lines.

The device 700 also includes computer-readable storage memory 712 (e.g., memory devices) that enable data storage, such as data storage devices that can be accessed by a computing device, and that provide persistent storage of data and executable instructions (e.g., software applications, programs, functions, and the like). Examples of the computer-readable storage memory 712 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 700 may also include a mass storage media device.

The computer-readable storage memory 712 provides data storage mechanisms to store the device data 704, other types of information and/or data, and various device applications 714 (e.g., software applications). For example, an operating system 716 can be maintained as software instructions with a memory device and executed by the processing system 708. The device applications may also include a device manager, such as any form of a control application, software application, signal-processing and control module, code that is native to a particular device, a hardware abstraction layer for a particular device, and so on. Computer-readable storage memory 712 represents media and/or devices that enable persistent and/or non-transitory storage of information in contrast to mere signal transmission, carrier waves, or signals per se. Computer-readable storage memory 712 do not include signals per se or transitory signals.

In this example, the device 700 includes an arbitrator module 718 and routing table data 720 that can implement aspects of audio link routing for do not disturb status and may be implemented with hardware components and/or in software. For example, the arbitrator module 718 can be implemented as the arbitrator module 120, described in detail above. In implementations, the arbitrator module 718 may include independent processing, memory, and logic components as a computing and/or electronic device integrated with the device 700. Further, the routing table data 720 can include data usable as part of the described techniques, such as to generate different routing tables 128.

In this example, the example device 700 also includes a camera 722 and sensors 724. The sensors 724 can be implemented in various ways and are representative of functionality to detect various physical and/or logical phenomena in relation to the device 700, such as motion, light, image detection and recognition, time and date, position, location, touch detection, sound, temperature, and so forth. Examples of the sensors 724 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth.

The device 700 also includes a wireless module 726, which is representative of functionality to perform various wireless communication tasks. The device 700 can also include one or more power sources 728, such as when the device is implemented as a mobile device. The power sources 728 may include a charging and/or power system, and can be implemented as a flexible strip battery, a rechargeable battery, a charged super-capacitor, and/or any other type of active or passive power source.

The device 700 also includes an audio and/or video processing system 730 that generates audio data for an audio system 732 and/or generates display data for a display system 734. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 736. In implementations, the audio system and/or the display system are integrated components of the example device. Alternatively, the audio system and/or the display system are external, peripheral components to the example device.

Although implementations of audio link routing for do not disturb status have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a first device including: at least one memory; and at least one processor coupled with the at least one memory and configured to cause the first device to: determine that an audio link to a wireless audio device is available to the first device and to a second device different than the first device; determine that the audio link is connected to the second device; receive a notification associated with an audio notification; compare state data associated with one or more of the first device or the second device to a routing table to determine a routing rule for the audio link, the state data including a do not disturb status of the second device; and determine, based at least in part on the routing rule, whether to connect the audio link to the first device and cause the audio notification to output via the wireless audio device.

In some aspects, the techniques described herein relate to a first device, wherein the first device includes a mobile device with wireless connectivity to the second device.

In some aspects, the techniques described herein relate to a first device, wherein the at least one processor is configured to cause the first device to communicatively connect the first device to the second device to enable an exchange of the state data between the first device and the second device.

In some aspects, the techniques described herein relate to a first device, wherein the at least one processor is configured to cause the first device and the second device to exchange the state data via one or more of Bluetooth Low Energy (BLE) advertisement or Generic Attribute Profile (GATT) communication.

In some aspects, the techniques described herein relate to a first device, wherein the at least one processor is configured to cause the first device to obtain the state data for the second device via one or more of an application or an application programming interface (API).

In some aspects, the techniques described herein relate to a first device, wherein the at least one processor is configured to cause the first device to determine that the wireless audio device is connected to the first device and the second device via dual wireless connectivity.

In some aspects, the techniques described herein relate to a first device, wherein: the do not disturb status of the second device indicates that do not disturb is active on the second device; and the routing rule indicates that the audio link is not to be disconnected from the second device while the do not disturb is active on the second device, wherein the at least one processor is configured to, based at least in part on the routing rule, cause the first device to prevent connection of the audio link to the first device while do not disturb is active on the second device.

In some aspects, the techniques described herein relate to a first device, wherein the at least one processor is configured to cause the first device to: receive further state data including an indication that do not disturb is deactivated on the second device; and cause, based at least in part on the further state data, the audio link to be connected to the first device and the audio notification to be output via the wireless audio device.

In some aspects, the techniques described herein relate to a first device, wherein the at least one processor is configured to cause the first device to cause the audio link to the wireless audio device to be transferred from the second device to the first device automatically and independent of user input to transfer the audio link.

In some aspects, the techniques described herein relate to a first device, wherein the at least one processor is configured to cause the first device to: receive further state data including an indication that do not disturb is deactivated on the second device; and cause, based at least in part on the further state data, one or more of: the first device to be connected to the wireless audio device and the audio notification to be output to the wireless audio device; or an indication of the notification to be transmitted to the second device.

In some aspects, the techniques described herein relate to a first device, wherein the indication of the notification includes a summary of notifications received at the first device while do not disturb was active on the second device.

In some aspects, the techniques described herein relate to a first device, wherein: the do not disturb status of the second device indicates that do not disturb is active on the second device; the notification includes a high priority notification; the routing rule indicates that, based at least in part on the high priority notification, the audio link is to be disconnected from the second device and connected to the first device while do not disturb is active on the second device; and wherein the at least one processor is configured to, based at least in part on the routing rule, cause the first device to connect the audio link to the first device and cause the audio notification to be output via the wireless audio device while do not disturb is active on the second device.

In some aspects, the techniques described herein relate to a first device including: at least one memory; and at least one processor coupled with the at least one memory and configured to cause the first device to: determine that an audio link to a wireless audio device is available to the first device and to a second device different than the first device; receive, while the audio link is connected to the first device, an indication that a notification is received at the second device, the notification associated with an audio notification; compare state data associated with one or more of the first device or the second device to a routing table to determine a routing rule for the audio link, the state data including a do not disturb status of the first device; and determine, based at least in part on the routing rule, whether to allow the audio link to be disconnected from the first device and connected to the second device to enable the audio notification to output via the wireless audio device.

In some aspects, the techniques described herein relate to a first device, wherein: the do not disturb status of the first device indicates that do not disturb is active on the first device; and the routing rule indicates that the audio link is not to be disconnected from the first device while the do not disturb is active on the first device, wherein the at least one processor is configured to, based at least in part on the routing rule, cause the first device to prevent disconnection of the audio link from the first device while do not disturb is active on the first device.

In some aspects, the techniques described herein relate to a first device, wherein the at least one processor is configured to cause the first device to: determine further state data including an indication that do not disturb is deactivated on the first device; and cause, based at least in part on the further state data, the audio link to be disconnected from the first device to enable the audio link to be connected to the second device.

In some aspects, the techniques described herein relate to a first device, wherein the at least one processor is configured to cause the first device to cause the audio link to the wireless audio device to be disconnected from the first device automatically and independent of user input to disconnect the audio link from the first device.

In some aspects, the techniques described herein relate to a first device, wherein the at least one processor is configured to cause the first device to: determine further state data including an indication that do not disturb is deactivated on the first device; and cause, based at least in part on the further state data, an indication of deactivation of do not disturb at the first device to be transmitted to the second device.

In some aspects, the techniques described herein relate to a first device, wherein the at least one processor is configured to cause the first device to: determine further state data including an indication that do not disturb is deactivated on the first device; receive, from the second device, an indication of the notification; and output, via the first device, the indication of the notification.

In some aspects, the techniques described herein relate to a first device, wherein: the do not disturb status of the first device indicates that do not disturb is active on the first device; the notification includes a high priority notification; the routing rule indicates that, based at least in part on the high priority notification, the audio link is to be disconnected from the first device and connected to the second device while do not disturb is active on the first device; and wherein the at least one processor is configured to, based at least in part on the routing rule, cause the first device to disconnect the audio link to the first device.

In some aspects, the techniques described herein relate to a system including: at least one memory; and at least one processor coupled to the at least one memory and configured to cause the system to: receive an indication that an audio link to a wireless audio device is available to a first device and to a second device different than the first device; determine that the audio link is connected to the first device; receive an indication of a notification received at the second device, the notification associated with an audio notification; compare state data associated with one or more of the first device or the second device to a routing table to determine a routing rule for the audio link, the state data including a do not disturb status of the first device; and transmit, based at least in part on the routing rule, a routing notification to one or more of the first device or the second device, the routing notification indicating whether the audio link is to be disconnected from the first device and connected to the second device to enable the audio notification to be output via the wireless audio device.

What is claimed is:

1. A first device comprising:
at least one memory; and
at least one processor coupled with the at least one memory and configured to cause the first device to:
determine that an audio link to a wireless audio device is available to the first device and to a second device different than the first device;
determine that the audio link is connected to the second device;
receive a notification associated with an audio notification;
compare state data associated with one or more of the first device or the second device to a routing table to determine a routing rule for the audio link, the state data including a do not disturb status of the second device; and
determine, based at least in part on the routing rule, whether to connect the audio link to the first device and cause the audio notification to output via the wireless audio device.

2. The first device of claim 1, wherein the first device comprises a mobile device with wireless connectivity to the second device.

3. The first device of claim 1, wherein the at least one processor is configured to cause the first device to communicatively connect the first device to the second device to enable an exchange of the state data between the first device and the second device.

4. The first device of claim 3, wherein the at least one processor is configured to cause the first device and the second device to exchange the state data via one or more of Bluetooth Low Energy (BLE) advertisement or Generic Attribute Profile (GATT) communication.

5. The first device of claim 1, wherein the at least one processor is configured to cause the first device to obtain the state data for the second device via one or more of an application or an application programming interface (API).

6. The first device of claim 1, wherein the at least one processor is configured to cause the first device to determine that the wireless audio device is connected to the first device and the second device via dual wireless connectivity.

7. The first device of claim 1, wherein:
the do not disturb status of the second device indicates that do not disturb is active on the second device; and
the routing rule indicates that the audio link is not to be disconnected from the second device while the do not disturb is active on the second device, wherein the at least one processor is configured to, based at least in part on the routing rule, cause the first device to prevent connection of the audio link to the first device while do not disturb is active on the second device.

8. The first device of claim 7, wherein the at least one processor is configured to cause the first device to:
receive further state data comprising an indication that do not disturb is deactivated on the second device; and
cause, based at least in part on the further state data, the audio link to be connected to the first device and the audio notification to be output via the wireless audio device.

9. The first device of claim 8, wherein the at least one processor is configured to cause the first device to cause the audio link to the wireless audio device to be transferred from the second device to the first device automatically and independent of user input to transfer the audio link.

10. The first device of claim 7, wherein the at least one processor is configured to cause the first device to:
receive further state data comprising an indication that do not disturb is deactivated on the second device; and
cause, based at least in part on the further state data, one or more of:
the first device to be connected to the wireless audio device and the audio notification to be output to the wireless audio device; or
an indication of the notification to be transmitted to the second device.

11. The first device of claim 10, wherein the indication of the notification comprises a summary of notifications received at the first device while do not disturb was active on the second device.

12. The first device of claim 1, wherein:
the do not disturb status of the second device indicates that do not disturb is active on the second device;
the notification comprises a high priority notification;
the routing rule indicates that, based at least in part on the high priority notification, the audio link is to be disconnected from the second device and connected to the first device while do not disturb is active on the second device; and
wherein the at least one processor is configured to, based at least in part on the routing rule, cause the first device to connect the audio link to the first device and cause the audio notification to be output via the wireless audio device while do not disturb is active on the second device.

13. A first device comprising:
at least one memory; and
at least one processor coupled with the at least one memory and configured to cause the first device to:
determine that an audio link to a wireless audio device is available to the first device and to a second device different than the first device;
receive, while the audio link is connected to the first device, an indication that a notification is received at the second device, the notification associated with an audio notification;
compare state data associated with one or more of the first device or the second device to a routing table to determine a routing rule for the audio link, the state data including a do not disturb status of the first device; and
determine, based at least in part on the routing rule, whether to allow the audio link to be disconnected from the first device and connected to the second device to enable the audio notification to output via the wireless audio device.

14. The first device of claim 13, wherein:
the do not disturb status of the first device indicates that do not disturb is active on the first device; and
the routing rule indicates that the audio link is not to be disconnected from the first device while the do not disturb is active on the first device, wherein the at least one processor is configured to, based at least in part on the routing rule, cause the first device to prevent disconnection of the audio link from the first device while do not disturb is active on the first device.

15. The first device of claim 14, wherein the at least one processor is configured to cause the first device to:
determine further state data comprising an indication that do not disturb is deactivated on the first device; and
cause, based at least in part on the further state data, the audio link to be disconnected from the first device to enable the audio link to be connected to the second device.

16. The first device of claim 15, wherein the at least one processor is configured to cause the first device to cause the audio link to the wireless audio device to be disconnected from the first device automatically and independent of user input to disconnect the audio link from the first device.

17. The first device of claim 14, wherein the at least one processor is configured to cause the first device to:
determine further state data comprising an indication that do not disturb is deactivated on the first device; and
cause, based at least in part on the further state data, an indication of deactivation of do not disturb at the first device to be transmitted to the second device.

18. The first device of claim 14, wherein the at least one processor is configured to cause the first device to:
determine further state data comprising an indication that do not disturb is deactivated on the first device;
receive, from the second device, an indication of the notification; and
output, via the first device, the indication of the notification.

19. The first device of claim 13, wherein:
the do not disturb status of the first device indicates that do not disturb is active on the first device;
the notification comprises a high priority notification;
the routing rule indicates that, based at least in part on the high priority notification, the audio link is to be disconnected from the first device and connected to the second device while do not disturb is active on the first device; and
wherein the at least one processor is configured to, based at least in part on the routing rule, cause the first device to disconnect the audio link to the first device.

20. A system comprising:
at least one memory; and
at least one processor coupled to the at least one memory and configured to cause the system to:
receive an indication that an audio link to a wireless audio device is available to a first device and to a second device different than the first device;
determine that the audio link is connected to the first device;
receive an indication of a notification received at the second device, the notification associated with an audio notification;
compare state data associated with one or more of the first device or the second device to a routing table to determine a routing rule for the audio link, the state data including a do not disturb status of the first device; and
transmit, based at least in part on the routing rule, a routing notification to one or more of the first device or the second device, the routing notification indicating whether the audio link is to be disconnected from the first device and connected to the second device to enable the audio notification to be output via the wireless audio device.
